(19) United States
(12) Patent Application Publication
(10) Pub. No.: US 2006/0147036 A1
(43) Pub. Date: Jul. 6, 2006

(54) Dailer having a loose-leaf notebook function

(76) Inventor: Yi-Chia Liao, Miao-Li County (TW)

Correspondence Address: BIRCH STEWART KOLASCH & BIRCH, PO BOX 747, FALLS CHURCH, VA, 22040-0747, US

(21) Appl. No.: 11/027,979

(22) Filed: Jan. 4, 2005

(51) Int. Cl. H04M 1/00

(52) U.S. Cl. 379/441

(57) ABSTRACT

The present invention discloses a dialer with a loose-page notebook function which includes a loose-page notebook body and a plurality of turnable telephone number pages, and the number of telephone number pages can be increased, not only providing a flexible number of memory dials for users, but also allowing users to quickly and conveniently find and dial their desired number by the telephone number and name of a person listed in the telephone number page, and thus the body of the invention has a function similar to a loose-page notebook for allowing users to memorize a telephone number without wasting time.

### FIELD OF THE INVENTION

The present invention relates to a dialer, more particularly to a dialer having a loose-leaf notebook function, such that a telephone call can be dialed after looking up the name of a call receiver by turning the pages of a directory notebook and then directly pressing the name to make the call, and the telephone numbers can be saved in a memory for making calls easier.

### BACKGROUND OF THE INVENTION

Telephone is a bridge for the communications between people and has become an indispensable tool for every household and company. Different telephones have their own numbers, and these telephone numbers are provided by a telephone company, and users can connect to a specific telephone by dialing a corresponding telephone number if a user is connected to a phone over a telecommunication network. Therefore, users just need to know their desired contact phone number to dial a call.

In general, a household or a company has its dedicated telephone directory for recording the frequently dialed telephone numbers. To save the dialing time, a dialer specially designed for dialing a telephone is introduced, being not only capable of remembering a number of sets of telephone numbers for making a quick dial, but also providing additional functions such as a redial of the previous number or a caller ID display. However, a general dialer is restricted by the number of press buttons and the limited memory for saving telephone numbers. Since the press buttons and the memory cannot be expanded flexibly, the user's requirements cannot be satisfied. Further, if the memory is full, a user cannot save a telephone number in the memory any more. Therefore, sometimes the user needs to write a telephone number in a slip of paper, indicating that the prior-art dialer can no longer meet the user's requirements.

### SUMMARY OF THE INVENTION

Therefore, the primary objective of the present invention is to provide a dialer capable of flexibly expanding the number of memory dials and directly dialing a telephone number by turning over the loose-leaf pages of a notebook.

The present invention comprises a body of a loose-leaf notebook and a plurality of telephone number pages, wherein the body has a control circuit for pre-storing a plurality of telephone numbers and a plurality of code buttons; the telephone number pages are pivotally coupled to the body by a pivotal axle to define a turning-page structure similar to a loose-page notebook, and the plurality of telephone numbers comes with an infrared sensor and the control circuit obtains a turning-page status of the telephone number pages by the infrared sensor, and the plurality of telephone numbers pre-stored in the control circuit is a two-dimensional matrix defined by the plurality of code buttons and the turning-page status of the plurality of the telephone number pages, such that if a user can press one of the code buttons from the plurality of telephone number pages, then the control circuit will select to dial the specified telephone number from the plurality of telephone numbers stored in the control circuit.

### BRIEF DESCRIPTION OF THE DRAWINGS

FIG. 1 is a perspective view of the structure of the present invention.

FIG. 2 is a block diagram of the control circuit of the present invention.

FIG. 3 is a perspective view of the structure according to another preferred embodiment of the present invention.

### DETAILED DESCRIPTION OF THE PREFERRED EMBODIMENTS

The above and other objects, features and advantages of the present invention will become apparent from the following detailed description taken with the accompanying drawing.

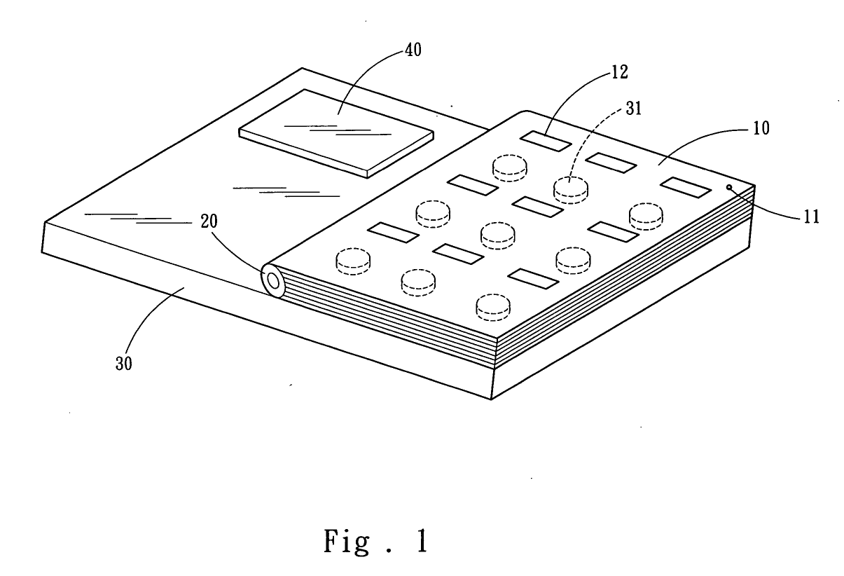

Please refer to FIG. 1 for the dialer having a loose-leaf notebook function, which includes a body 30, and the body 30 comprises a control circuit 40 for pre-storing a plurality of telephone numbers; a plurality of code buttons 31 disposed on the body 30; a plurality of telephone number pages being pivotally coupled onto the body 30 by a pivotal axle 20, thereby a turning-page structure similar to a loose-page notebook is defined and covers the code buttons 31. The plurality of telephone number pages 10 separately has an infrared sensor 11 (such infrared sensor 11 cannot be visually observed by the user), and the control circuit 40 obtains a turning-page status of the plurality of telephone number pages 10 by the infrared sensor 11. The plurality of telephone numbers pre-stored into the control circuit 40 is associated with a two-dimensional matrix defined by the plurality code buttons 31 corresponding to the plurality of pre-stored telephone numbers and the turning-page status of the plurality of telephone number pages 10.

When the dialer is in use, a user presses one of the plurality of code buttons 31 from the plurality of telephone number pages 10, and the control circuit 40 will select the desired number from the plurality of pre-stored telephone numbers according to the association between the plurality of pre-stored telephone numbers and the two-dimensional matrix and the plurality of telephone number pages 10 has a plurality of corresponding telephone number labels 12 in the area of the plurality of code buttons for stating the telephone numbers represented by the plurality of code buttons respectively.

Therefore, the two-dimensional matrix defined by the plurality of code buttons 31 and the turning-page status of the plurality of the telephone number pages 10 is used to pre-store the telephone numbers in the control circuit 40 and write the plurality of telephone number pages 10 into the corresponding positions of the plurality of telephone number pages 10, so that a user can turn over the plurality of telephone number pages to look up a desired telephone number for directly dialing a call. Further, the telephone number pages 10 of the present invention can be added appropriately as needed to increase the number of memory dials.

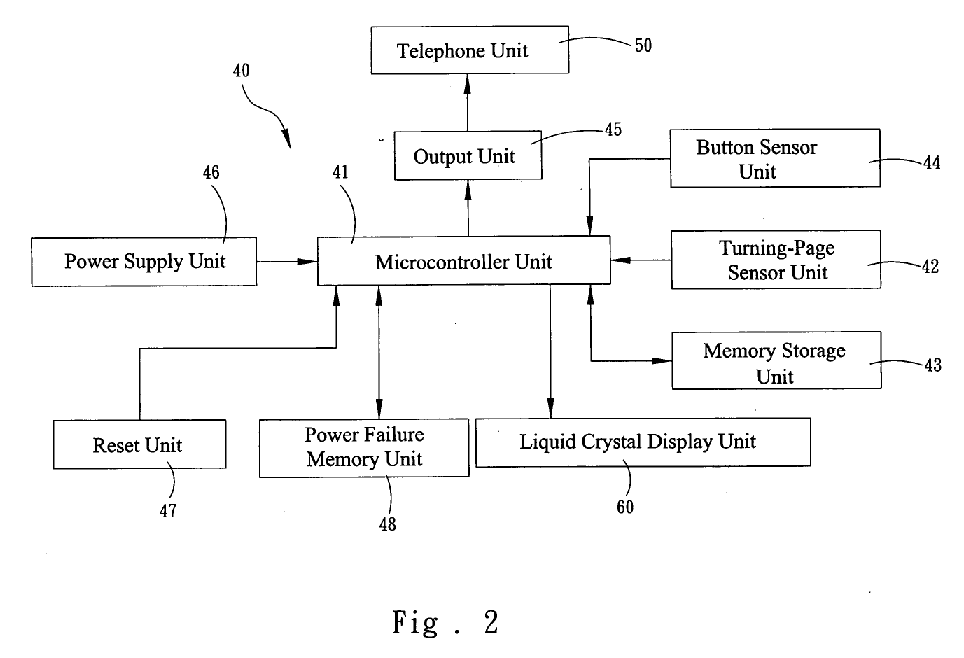

Please refer to FIG. 2 for the control circuit 40 comprising a microcontroller unit 41, a turning page sensor unit 41, a memory storage unit 43, a button sensor unit 44, an output unit 45, and a power supply unit 46; wherein the power supply unit 46 supplies the electric power required for every unit of the control circuit 40; the memory storage unit 43 stores a plurality of pre-stored telephone numbers; the turning-page sensor unit 42 receives a signal from the infrared sensor 11 to obtain the turning-page status of the plurality of the telephone number pages 10 and input the signal to the microcontroller 41, and the signal of the code button is received by the button sensor unit 41. The signal is inputted into the microcontroller unit 41, and the microcontroller 41 integrates the two signals. The memory storage unit 42 sends a selected telephone number to the output unit 45, and the output unit 45 is connected to a telephone unit 50 for receiving the selected telephone number transmitted from the output unit 45 for dialing a call. The control circuit 40 further comprises a reset unit 47 for resetting every unit of the control circuit 40 for their execution; a power failure memory unit 48 comprised of a flash memory for preventing a data loss during a power failure; and a liquid crystal display unit 60 for displaying various statuses of the control circuit 40, such that a user can easily and conveniently use the product according to the invention.

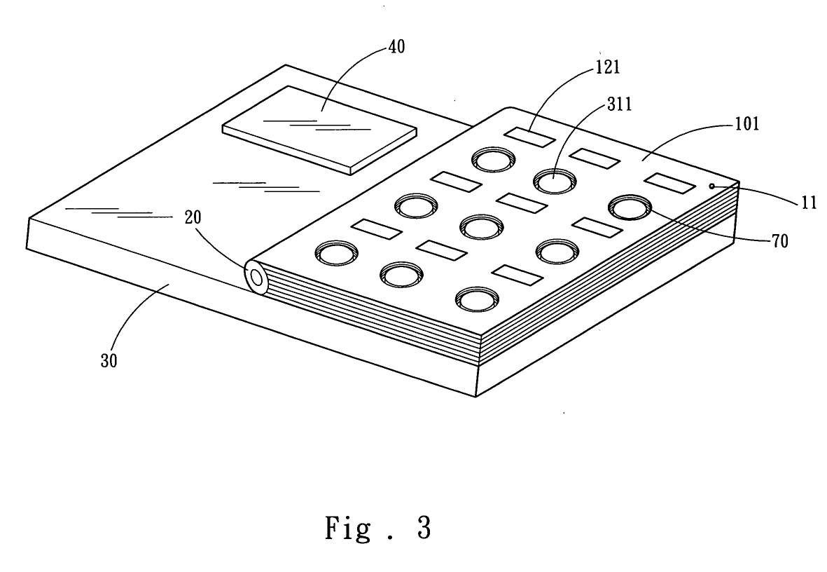

Please refer to FIG. 3 for another preferred embodiment of the present invention. The plurality of telephone number pages 101 includes a plurality of hollow openings 70 for exposing the plurality of code buttons 311, and the plurality of telephone number pages 101 disposed in the area adjacent to the plurality of code buttons 311 (which is adjacent to the plurality of the hollow openings 70) respectively has a plurality of telephone labels 121 for stating the telephone numbers represented by the plurality of code buttons 311, such that a user can directly press the plurality of code buttons 311, not only can prevent the plurality of telephone number labels from being peeled off or damaged due to the wearing of the plurality of telephone number pages 101, but also can prevent a user from pressing a wrong code button 311 from the plurality of code buttons 311 of the plurality of telephone number pages 101.

Therefore, the body 30 of the present invention is designed as a loose-leaf notebook, and the body 30 has a plurality of turnable telephone number pages 10, 101 (similar to a loose-leaf notebook). With the characteristic of the telephone number pages 10, 101 capable of being increased as needed, a user can flexibly add a number of memory dials and use the telephone number labels 12, 121 (which could be a company name or a person's name) in the telephone number pages 10, 101 to conveniently and quickly look up a desired telephone number similar to turning the pages of a notebook and make a quick dial through the memory dial. Therefore, a user no longer needs to waste time to memorize a plurality of telephone numbers, but just adopts the common habit of turning over the pages of a notebook to conveniently use the dialer in accordance with the present invention.

What is claimed is:

1. A dialer having a loose-leaf notebook function, comprising:
a body, including a control circuit for pre-storing a plurality of telephone numbers in said control circuit and said body further including a plurality of code buttons;
a plurality of telephone number pages, being pivotally coupled to said body to define a turning page structure similar to a loose-page notebook, and respectively having an infrared sensor, such that said control circuit obtains a turning-page status of said plurality of telephone number pages through said infrared sensor, and said plurality of pre-stored telephone numbers being associated with a two-dimensional matrix defined by said plurality of code buttons and the turning-page status of said plurality of telephone number pages, such that if a user presses one of said code buttons from said plurality of telephone number pages, said control circuit selects and dials a specified telephone number from said plurality of pre-stored telephone numbers.

2. The dialer having a loose-leaf notebook function of claim 1, wherein said plurality of telephone number pages respectively has a plurality of telephone number labels disposed in the area corresponding to said plurality of code buttons for stating the telephone numbers represented by said plurality of code buttons.

3. The dialer having a loose-leaf notebook function of claim 1, wherein said control circuit comprises a microcontroller unit, a turning-page sensor unit, a memory storage unit, a button sensor unit, an output unit, and a power supply unit; said power supply unit supplies the electric power required by every unit of said control circuit; said memory storage unit stores said plurality of pre-stored telephone numbers; said turning-page sensor receives a signal from said infrared sensor to obtain a turning-page status of said plurality of telephone number pages and input it into said microcontroller unit, and then said microcontroller unit receives a signal of said code button and inputs it into said microcontroller unit; said microcontroller unit integrates both signals; said memory storage unit sends a specified number from said plurality of pre-stored telephone numbers to said output unit; said output unit is coupled to a telephone unit, such that said telephone unit receives a specified telephone number in said plurality of pre-stored telephone numbers transmitted from said output unit for dialing a telephone call.

4. The dialer having a loose-leaf notebook function of claim 3, wherein said control circuit further comprises a reset unit.

5. The dialer having a loose-leaf notebook function of claim 3, wherein said control circuit further comprises a power failure memory unit.

6. The dialer having a loose-leaf notebook function of claim 3 further comprising a liquid crystal display unit.

7. The dialer having a loose-leaf notebook function of claim 1, wherein said plurality of telephone number pages comprises a plurality of hollow openings for exposing said plurality of code buttons.

8. The dialer having a loose-leaf notebook function of claim 7, wherein said plurality of telephone number pages has a plurality of telephone number labels disposed adjacent to said plurality of hollow openings for stating the use of said plurality of code buttons.
